(19) United States
(12) Patent Application Publication
(10) Pub. No.: US 2026/0184249 A1
(43) Pub. Date: Jul. 2, 2026

(54) ARMREST AND VEHICLE SEAT

(71) Applicants: TS TECH CO., LTD., Saitama (JP); HONDA MOTOR CO., LTD., Tokyo (JP)

(72) Inventors: Yoshiaki ITO, Tochigi (JP); Tsuyoshi KOMORI, Tochigi (JP); Manabu MATSUMOTO, Tokyo (JP); Yusuke OGATA, Tokyo (JP)

(21) Appl. No.: 19/418,308

(22) Filed: Dec. 12, 2025

(30) Foreign Application Priority Data
Dec. 26, 2024 (JP) 2024-231177

(51) Int. Cl. B60N 2/75; B60H 1/00; B60N 3/10

(52) U.S. Cl. CPC B60N 2/757; B60H 1/00564; B60N 2/793; B60N 3/10

(57) ABSTRACT

An armrest includes an armrest body, and a device supported on a surface of the armrest body, and the armrest body is provided with a flow-through passage, an upstream side of the flow-through passage being connected to the device, and a downstream side of the flow-through passage opening on the surface of the armrest body at a position that does not overlap the device.

### TECHNICAL FIELD

The present invention relates to an armrest and a vehicle seat provided with the armrest.

### BACKGROUND ART

JP2019-094027A discloses a door trim including an armrest portion. The armrest portion is formed to bulge into an interior of a vehicle and is used as an armrest for an occupant. The armrest portion is provided with an accommodating portion open at the top.

The accommodating portion includes a bottom wall, a pair of sidewalls, and a rear wall, and one of the sidewalls includes an inclined surface on which an electronic device, such as a smartphone, can be arranged. A coil (power supply coil) is embedded in the inclined surface to charge the electronic device by transmitting power in a contactless manner.

The power supply coil described in JP2019-094027A is embedded in the inclined surface. Accordingly, there is a problem that heat generated by the power supply coil is difficult to dissipate from the accommodating portion to the outside.

### SUMMARY OF THE INVENTION

In view of the above background, an object of the present invention is to provide an armrest capable of effectively dissipating heat from a device, and a vehicle seat provided with the armrest.

To achieve such an object, one aspect of the present invention provides an armrest (15, 101) comprising: an armrest body (21, 103); and a device (18) supported on a surface of the armrest body, and the armrest body is provided with a flow-through passage (72U, 131), an upstream side of the flow-through passage being connected to the device, and a downstream side of the flow-through passage opening on the surface of the armrest body at a position that does not overlap the device.

According to this aspect, since the flow-through passage is provided in the armrest, heat from the device can be effectively dissipated through the flow-through passage.

In the above aspect, preferably, the device is supported on a free end side of the armrest body, and a downstream end of the flow-through passage is provided on a base end side of the armrest body.

According to this aspect, it is possible to provide the device at a position on a seat where the device can be easily operated by the seated person.

In the above aspect, preferably, a downstream end of the flow-through passage is provided with a cover (139) including a vent hole (143).

According to this aspect, it is possible to form the flow-through passage by the cover.

In the above aspect, preferably, the armrest body includes a support member (109) on which the device is arranged and a duct (111) supported by the support member, the support member includes a support portion (117) that forms a surface for supporting the device on a top side, and a connecting portion (119) that opens at the support portion and extends to a back side, and the duct is formed in a groove shape at a position facing the support member, is connected to the connecting portion, abuts against a back surface of the support member, and defines the downstream side of the flow-through passage.

According to this aspect, it is possible to constitute the flow-through passage leading to the device with a simple structure.

In the above aspect, preferably, the armrest body is provided with a rotation shaft (34) for rotatably connecting the armrest body to a seat back, and the rotation shaft extends in a lateral direction and passes through the duct.

According to this aspect, the duct is arranged so as to overlap with the rotation shaft in a side view. Accordingly, it is possible to make the armrest body more compact than when the duct is provided at a position away from the rotation shaft.

In the above aspect, preferably, the duct includes a bottom wall (111A) and a pair of sidewalls (111B) extending upward from the bottom wall, each of the pair of sidewalls is provided with a notch portion (135) cut in a direction away from the support member, and the rotation shaft passes through the notch portion.

According to this aspect, it is possible to arrange the duct so as to overlap with the rotation shaft in a side view.

In the above aspect, preferably, a fixing portion (149) for fixing a harness connected to the device is provided on a downstream side of the duct.

According to this aspect, since there is no need to provide a separate member for fixing the harness to the support member, it is possible to reduce the number of components of the armrest.

In the above aspect, preferably, a pad member (105) is provided on the back side of the armrest body, and the pad member is provided with a receiving recess (133) that receives the connecting portion and the duct.

According to this aspect, it is possible to satisfactorily couple the support member and the duct to the pad member.

In the above aspect, preferably, the duct is provided with a pair of restricting pieces (155) protruding toward the pad member, and the pad member is provided with a bulging portion (159) extending into a space between the pair of restricting pieces.

According to this aspect, it is possible to restrict a movement of the pad member relative to the duct by the bulging portion and the pair of restricting pieces.

In the above aspect, preferably, each of the pair of restricting pieces is provided with a rib (161) having a surface, the surface of the rib of one of the restricting pieces facing the surface of the rib of the other, and the bulging portion is sandwiched between the ribs.

According to this aspect, since the bulging portion is sandwiched between the ribs, it is possible to effectively restrict the movement of the pad member relative to the duct.

In the above aspect, preferably, the device is a power supply device (18) for supplying power to a terminal.

According to this aspect, it is possible to supply power to the terminal using the device provided in the armrest.

Another aspect of the present invention provides a vehicle seat (1) including the armrest, and the armrest body is rotatably connected to a seat back at a base end side of the armrest body about an axis extending in a lateral direction, and the seat back is provided with a storage recess (16) to store the armrest.

According to this aspect, it is possible to provide the vehicle seat including a retractable armrest capable of effectively dissipating the heat from the device.

### EFFECT OF THE INVENTION

One aspect of the present invention provides an armrest (15, 101) comprising: an armrest body (21, 103); and a device (18) supported on a surface of the armrest body, and the armrest body is provided with a flow-through passage (72U, 131), an upstream side of the flow-through passage being connected to the device, and a downstream side of the flow-through passage opening on the surface of the armrest body at a position that does not overlap the device.

According to this aspect, since the flow-through passage is provided in the armrest, heat from the device can be effectively dissipated through the flow-through passage.

In the above aspect, preferably, the device is supported on a free end side of the armrest body, and a downstream end of the flow-through passage is provided on a base end side of the armrest body.

According to this aspect, it is possible to provide the device at a position on a seat where the device can be easily operated by the seated person.

In the above aspect, preferably, a downstream end of the flow-through passage is provided with a cover (139) including a vent hole (143).

According to this aspect, it is possible to form the flow-through passage by the cover.

In the above aspect, preferably, the armrest body includes a support member (109) on which the device is arranged and a duct (111) supported by the support member, the support member includes a support portion (117) that forms a surface for supporting the device on a top side, and a connecting portion (119) that opens at the support portion and extends to a back side, and the duct is formed in a groove shape at a position facing the support member, is connected to the connecting portion, abuts against a back surface of the support member, and defines the downstream side of the flow-through passage.

According to this aspect, it is possible to constitute the flow-through passage leading to the device with a simple structure.

In the above aspect, preferably, the armrest body is provided with a rotation shaft (34) for rotatably connecting the armrest body to a seat back, and the rotation shaft extends in a lateral direction and passes through the duct.

According to this aspect, the duct is arranged so as to overlap with the rotation shaft in a side view. Accordingly, it is possible to make the armrest body more compact than when the duct is provided at a position away from the rotation shaft.

In the above aspect, preferably, the duct includes a bottom wall (111A) and a pair of sidewalls (111B) extending upward from the bottom wall, each of the pair of sidewalls is provided with a notch portion (135) cut in a direction away from the support member, and the rotation shaft passes through the notch portion.

According to this aspect, it is possible to arrange the duct so as to overlap with the rotation shaft in a side view.

In the above aspect, preferably, a fixing portion (149) for fixing a harness connected to the device is provided on a downstream side of the duct.

According to this aspect, since there is no need to provide a separate member for fixing the harness to the support member, it is possible to reduce the number of components of the armrest.

In the above aspect, preferably, a pad member (105) is provided on the back side of the armrest body, and the pad member is provided with a receiving recess (133) that receives the connecting portion and the duct.

According to this aspect, it is possible to satisfactorily couple the support member and the duct to the pad member.

In the above aspect, preferably, the duct is provided with a pair of restricting pieces (155) protruding toward the pad member, and the pad member is provided with a bulging portion (159) extending into a space between the pair of restricting pieces.

According to this aspect, it is possible to restrict a movement of the pad member relative to the duct by the bulging portion and the pair of restricting pieces.

In the above aspect, preferably, each of the pair of restricting pieces is provided with a rib (161) having a surface, the surface of the rib of one of the restricting pieces facing the surface of the rib of the other, and the bulging portion is sandwiched between the ribs.

According to this aspect, since the bulging portion is sandwiched between the ribs, it is possible to effectively restrict the movement of the pad member relative to the duct.

In the above aspect, preferably, the device is a power supply device (18) for supplying power to a terminal.

According to this aspect, it is possible to supply power to the terminal using the device provided in the armrest.

Another aspect of the present invention provides a vehicle seat (1) including the armrest, and the armrest body is rotatably connected to a seat back at a base end side of the armrest body about an axis extending in a lateral direction, and the seat back is provided with a storage recess (16) to store the armrest.

According to this aspect, it is possible to provide the vehicle seat including a retractable armrest capable of effectively dissipating the heat from the device.

### BRIEF DESCRIPTION OF THE DRAWING(S)

FIG. 1 is a perspective view of a rear seat provided with an armrest according to a first embodiment of the present invention;

FIG. 2 is a perspective view of the armrest as seen from the left side;

FIG. 3 is an exploded perspective view of the armrest;

FIG. 4A is a top view of the armrest;

FIG. 4B is a bottom view of the armrest with a back-side pad member removed;

FIG. 5 is a cross-sectional view taken along a line V-V of FIG. 2;

FIG. 6 is a perspective view of the armrest with a cover, an upper pad member, a device, and a skin material removed;

FIG. 7 is a rear perspective view of a tray;

FIG. 8 is the rear view of the tray;

FIG. 9 is a perspective view of the armrest with the skin material removed, as seen from an oblique rearward direction;

FIG. 10 is a perspective view of the armrest according to a second embodiment of the present invention as seen from the left side;

FIG. 11 is an exploded perspective view of an armrest body according to the second embodiment;

FIG. 12 is a perspective view showing a restricting mechanism and a fixing portion according to the second embodiment;

FIG. 13 is a cross-sectional view taken along line XIII-XIII of FIG. 10;

FIG. 14 is a perspective view of a duct and a support member to which a cap is coupled, as seen from below;

FIG. 15 is a top view showing an arrangement of a lower pad member, the duct, and the cover; and

FIG. 16 is a rear view of the cover.

### DETAILED DESCRIPTION OF THE INVENTION

In the following, an embodiment of the present invention applied to an armrest of a three-seater rear seat of an automobile will be described with reference to the drawings. However, the present invention can also be applied to the armrest provided in a mid-seat, a front seat, a door trim, a center console box, and the like.

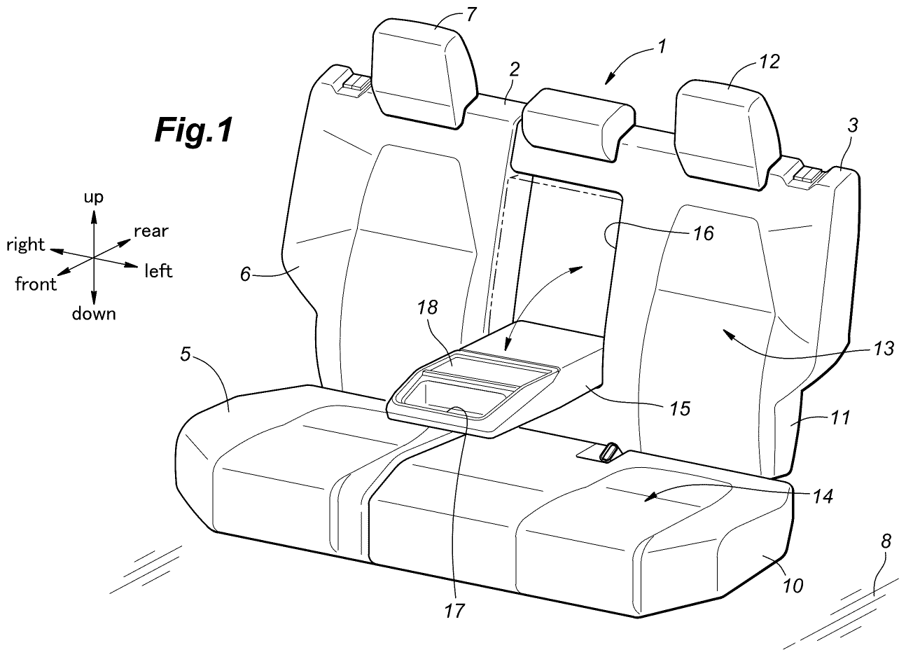

As shown in FIG. 1, a rear seat 1 includes a right seat 2 constituting the right seat and a left seat 3 constituting the left and center seats. The left seat 3 and the right seat 2 are independent of each other and are arranged continuously in the lateral direction.

The right seat 2 includes a seat cushion 5, a seat back 6, and a headrest 7. The seat cushion 5 is coupled to a floor 8, and the seat back 6 is coupled to the rear end of the seat cushion 5. The headrest 7 is coupled to the upper portion of the seat back 6.

The left seat 3 includes a seat cushion 10, a seat back 11, a headrest 12, and an armrest 15. The seat cushion 10 is coupled to the floor 8, and the seat back 11 is coupled to the rear end of the seat cushion 10. The headrest 12 is coupled to the upper portion of the seat back 11.

The right seat 2 and the left seat 3 are arranged continuously in the lateral direction. The seat back 6 of the right seat 2 and the seat back 11 of the left seat 3 are integrated together to constitute a seat back 13 of the rear seat 1. The seat cushion 5 of the right seat 2 and the seat cushion 10 of the left seat 3 are integrated together to constitute a seat cushion 14 of the rear seat 1.

A storage recess 16, which is recessed rearward, is formed in a portion of the front surface of the seat back 11 that constitutes the center seat. The base end of the armrest 15 is arranged inside the storage recess 16 and is connected to the seat back 11 so as to be rotatable about a rotation axis extending in a lateral direction. The armrest 15 rotates between a use position (see the solid line in FIG. 1) in which the free end projects forward relative to the base end, and a storage position (see the broken line in FIG. 1) in which the free end is arranged above the base end and stored inside the storage recess 16.

<<First embodiment>> In the following, a structure of the armrest 15 according to the first embodiment will be described based on a state in which the armrest 15 is in the use position.

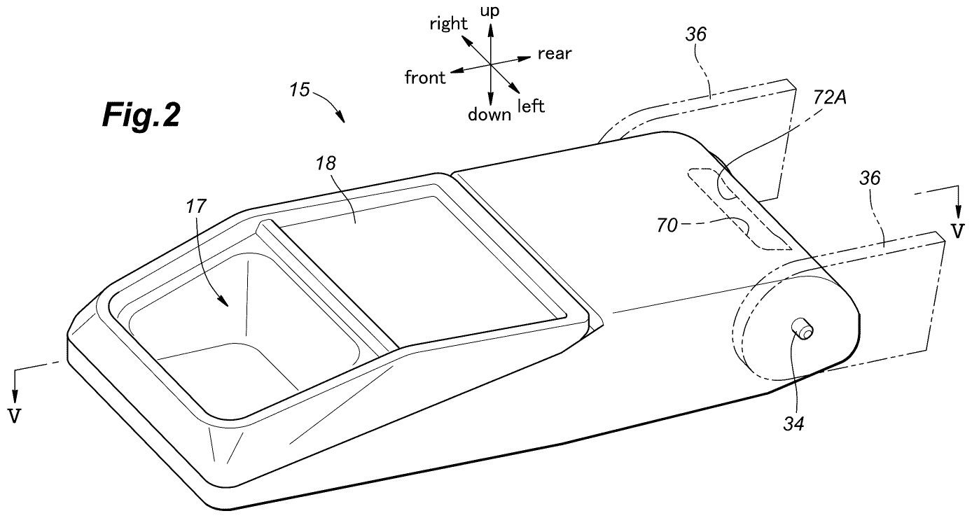

As shown in FIG. 2, the armrest 15 includes on the front end (i.e., free end) side thereof an accommodating recess 17 that is recessed downward. The accommodating recess 17 is used to accommodate various items such as drinking cups.

The armrest 15 includes a contactless power supply device 18 for charging terminals such as smartphones. The power supply device 18 is arranged slightly forward of the center of the armrest 15 and positioned behind the accommodating recess 17. By providing the power supply device 18 slightly forward of the center of the armrest 15, the power supply device 18 can be arranged in a position that is easily reachable by the seated person.

However, the power supply device 18 is an example of a device that may be provided in the armrest 15, and the armrest 15 may be provided with any device that is driven by electric power supplied from a battery mounted on the automobile. For example, the device provided in the armrest 15 may be a liquid crystal panel, a heater, a fan, or the like.

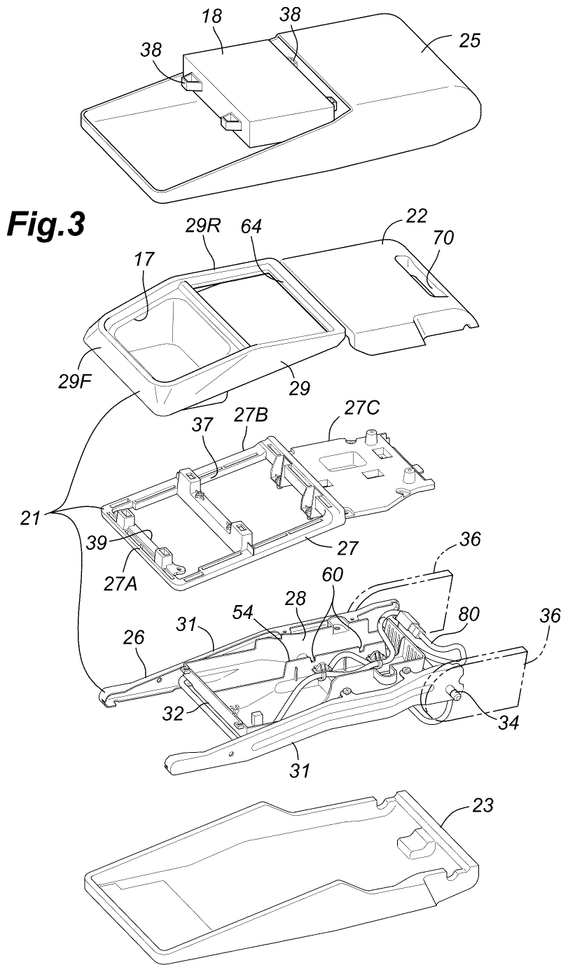

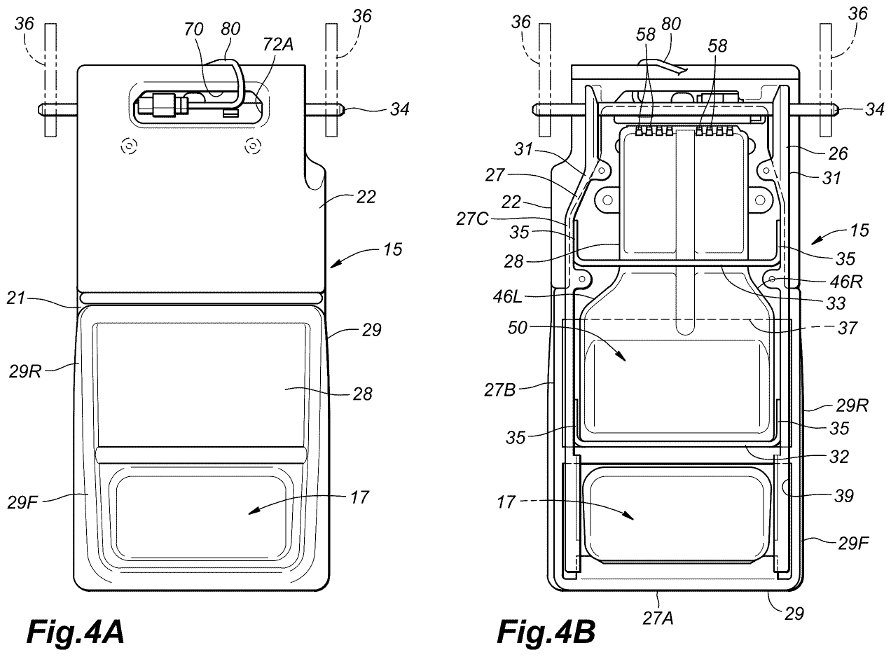

As shown in FIG. 3, the armrest 15 includes, in addition to the power supply device 18, an armrest body 21, an upper pad member 22 (see also FIG. 4A) arranged along the upper surface of the armrest body 21, a lower pad member 23 provided on the underside of the armrest body 21, and a skin material 25 covering the outer surfaces of the upper pad member 22 and the lower pad member 23.

As shown in FIGS. 3, 4A and 4B, the armrest body 21 includes a frame 26 (see FIGS. 3 and 4B), a cover 27 (see FIGS. 3 and 4B) supported by the frame 26, a tray 28 (see FIGS. 3 and 4B) coupled to the lower surface of the cover 27, and a cap 29 (see FIGS. 3 and 4A) coupled to the upper surface of the cover 27.

As shown in FIG. 4B, the frame 26 includes a pair of left and right side members 31, a front member 32 and a rear member 33 connecting the left and right side members 31, and a shaft 34.

As shown in FIG. 3, the side members 31 are formed of metal plates having surfaces facing in the lateral direction. As shown in FIG. 4B, the front member 32 and the rear member 33 are each formed of a metal wire member. The front member 32 is arranged in front of the rear member 33. The front member 32 and the rear member 33 each have bent portions 35 that are bent rearward at the left and right ends thereof, and are welded to the front member 32 and the rear member 33 at the bent portions 35.

The shaft 34 is formed of a metal round bar extending in the lateral direction. The shaft 34 penetrates the left side member 31 near the left end and further protrudes toward the left. The shaft 34 is fixed to the left side member 31 near the left end by welding and the like. The shaft 34 penetrates the right side member 31 near the right end and further protrudes toward the right. The shaft 34 is fixed to the right side member 31 near the right end by welding and the like.

As shown in FIG. 2, both ends of the shaft 34 are rotatably connected to brackets 36 fixed to the seat back 11 (more specifically, the frame of the seat back 11). That is, the shaft 34 constitutes a connecting portion for connecting the armrest body 21 to the seat back 11. A known locking mechanism may be provided between the shaft 34 and the bracket 36 to lock the position of the armrest 15 in the storage position or the use position.

The cover 27 is formed of a resin member. As shown in FIGS. 3 and 4B, the cover 27 has a substantially rectangular shape in a top view. The left edge of the cover 27 is fastened to the upper portion of the left side member 31, and the right edge of the cover 27 is fastened to the upper portion of the right side member 31. Accordingly, the cover 27 is supported by the left and right side members 31.

In the present embodiment, as shown in FIG. 3, the cover 27 includes a cover front portion 27A that constitutes the front portion, a cover center portion 27B that constitutes the center portion, and a cover rear portion 27C that constitutes the rear portion. The cover front portion 27A, the cover center portion 27B, and the cover rear portion 27C each have a substantially rectangular shape in a top view.

The cover 27 includes an accommodating hole 37 extending in the up-and-down direction to accommodate the power supply device 18. In the present embodiment, the accommodating hole 37 is provided in the cover center portion 27B, which has a substantially square frame shape.

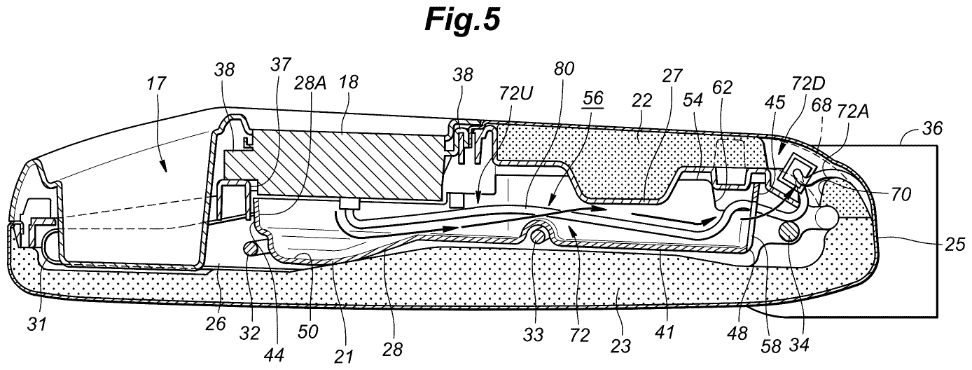

As shown in FIG. 5, the power supply device 18 is accommodated in the accommodating hole 37. Hooks 38, which are hooked onto the edges of the accommodating holes 37, are provided at the front and rear edges of the power supply device 18. The hook 38 engages with the edges of the accommodating hole 37, and the power supply device 18 is coupled to the cover 27. Accordingly, the power supply device 18 is coupled to the frame 26 via the cover 27 while being accommodated in the accommodating hole 37, and is supported on the surface of the armrest body 21.

As shown in FIGS. 3 and 4B, the cover front portion 27A includes a front hole 39 extending in the up-and-down direction, and the cover front portion 27A has a substantially square frame shape.

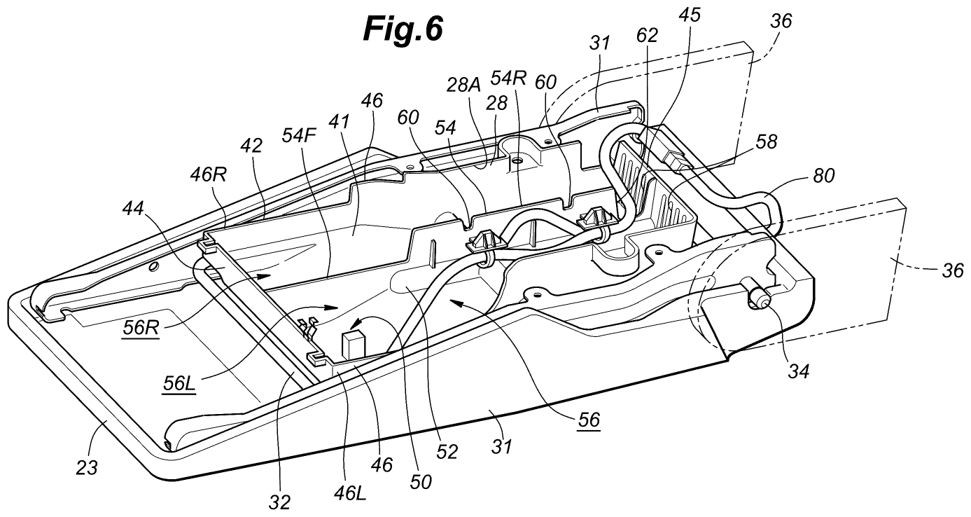

As shown in FIG. 6, the tray 28 is constituted by a box body formed in a rectangular tubular shape with a bottom. The tray 28 includes an opening 28A in the upper portion and is open upward. As shown in FIG. 5, the tray 28 is arranged behind the front member 32 and above the rear member 33. As shown in FIG. 4B, the tray 28 is coupled to the lower surface of the cover 27 by fastening and the like. Accordingly, the opening 28A of the tray 28 is closed from above by the cover 27. That is, as shown in FIG. 5, the cover 27 functions as a lid that closes a portion of the opening 28A of the tray 28. The tray 28 is coupled to the cover 27 and is supported by the side member 31 via the cover 27.

The tray 28 is fastened to the lower surfaces of the cover center portion 27B and the cover rear portion 27C, and is arranged slightly rearward of the lower surface of the cover 27 in the front-and-rear direction.

As shown in FIG. 6, the tray 28 includes a bottom wall 41 that has a substantially rectangular shape extending in the front-and-rear direction, and a peripheral wall 42 that extends upward from the bottom wall 41 along the edges thereof.

The peripheral wall 42 includes a front wall 44 extending upward from the bottom wall 41 along the front edges thereof, a rear wall 45 extending upward from the bottom wall 41 along the rear edge thereof, and a pair of left and right sidewalls 46 extending upward from the bottom wall 41 along the left and right side edges thereof. The front wall 44 is arranged on the free end side of the armrest body 21, and the rear wall 45 is arranged on the base end side of the armrest body 21. The left sidewall 46 (hereinafter referred to as left wall 46L) connects the left edge of the front wall 44 and the left edge of the rear wall 45. The right sidewall 46 (hereinafter referred to as right wall 46R) connects the right edge of the front wall 44 and the right edge of the rear wall 45.

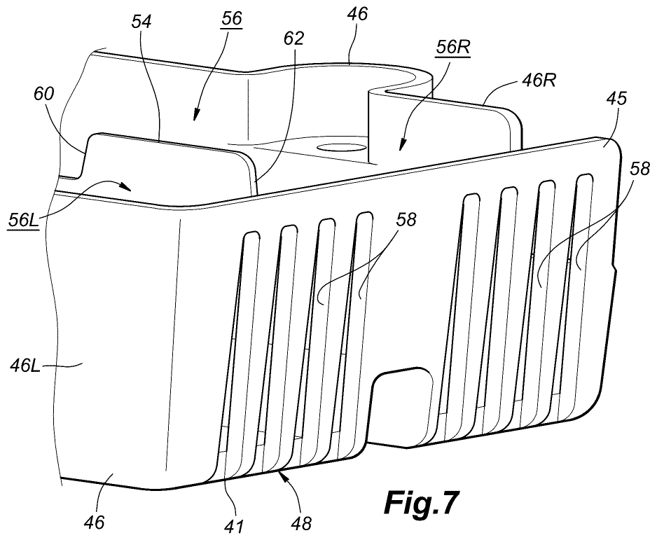

In the present embodiment, as shown in FIG. 7, a corner 48, which is gently curved in an arc shape in a side view, is provided between the rear wall 45 and the bottom wall 41. The corner 48 is connected to the rear wall 45 at the upper end, and extends downward and forward, and is gently curved in an arc shape in a side view. The corner 48 is connected to the bottom wall 41 at the lower end thereof.

As shown in FIGS. 4 and 6, the left wall 46L and the right wall 46R extend rearward from the front end, are bent so as to be close to each other at substantially the central portion in the front-and-rear direction, and further extend rearward. Accordingly, the lateral distance between the left wall 46L and the right wall 46R on the base end side (the rear end side) is smaller than the lateral distance between the left wall 46L and the right wall 46R on the free end side (the front end side).

As shown in FIG. 5, a bottom wall recess 50 that is recessed downward is provided in the front half of the bottom wall 41. The bottom wall recess 50 is formed by the front half of the bottom wall 41 bulging downward. The bottom wall recess 50 is provided at a position aligned with the accommodating hole 37 in the up-and-down direction. The bottom wall recess 50 overlaps the accommodating hole 37 in a top view.

As shown in FIG. 6, a raised portion 52 projecting upward is provided in the rear half of the bottom wall 41. The raised portion 52 extends in the front-and-rear direction at substantially the center of the left wall 46L and the right wall 46R.

The bottom wall 41 is provided with at least one rib 54 extending in the front-and-rear direction. The rib 54 has a wall-like shape with a surface facing the lateral direction. The rib 54 extends in the front-and-rear direction at substantially the central portion of the left wall 46L and the right wall 46R. The rib 54 is connected to the rear surface of the front wall 44 at the front end and connected to the front surface of the rear wall 45 at the rear end. By providing the rib 54 that connects the front wall 44 and the rear wall 45, the rigidity of the armrest body 21 can be increased.

In the present embodiment, one rib 54 is provided on the bottom wall 41. The rib 54 includes a front rib 54F extending in the front-and-rear direction at the bottom wall recess 50 and a rear rib 54R extending in the front-and-rear direction at the upper surface of the raised portion 52. The front end of the front rib 54F is coupled to the rear surface of the front wall 44, and the rear end of the front rib 54F is coupled to the front end of the rear rib 54R. The rear end of the rear rib 54R is coupled to the front surface of the rear wall 45.

By providing the rib 54 on the bottom wall 41, a space 56 inside the tray 28 is divided into two spaces 56: the space 56 arranged on the left side of the rib 54 (hereinafter, left space 56L) and the space 56 arranged on the right side of the rib 54 (hereinafter, right space 56R).

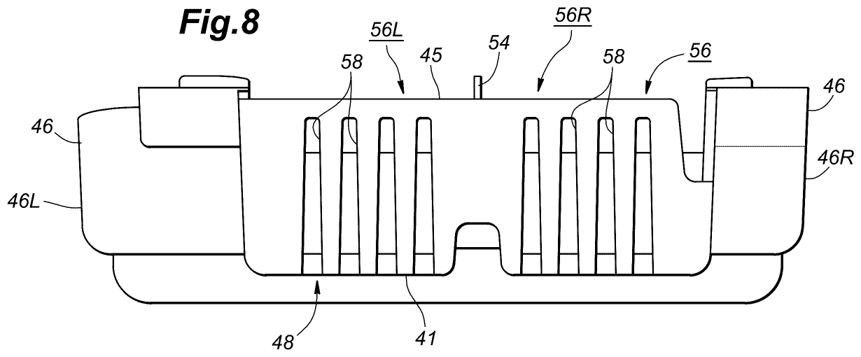

As shown in FIGS. 7 and 8, the rear wall 45 is provided with a slit 58 extending in the front-and-rear direction. The slit 58 is provided at a position that avoids the connecting portion between the rib 54 and the rear wall 45. The rear wall 45 may be provided with a plurality of slits 58 in each of a portion arranged on the left side of the rib 54 and a portion arranged on the right side of the rib 54. The slits 58 have substantially the same shape when viewed from the rear. In the present embodiment, four slits 58 are provided in each of the left-side portion and right-side portion of the rib 54.

As shown in FIG. 8, the slit 58 extends downward from a portion below the upper edge of the rear wall 45 and reaches the lower edge of the rear wall 45. As shown in FIGS. 5 and 7, the slit 58 may further extend from the lower edge of the rear wall 45, pass through the corner 48, and reach the inside of the bottom wall 41.

As shown in FIG. 8, the left wall surface that defines the left edge of the slit 58 and the right wall surface that defines the right edge of the slit 58 are configured to diverge toward a downward direction. Accordingly, the slit 58 is configured to widen toward the downward direction (i.e., toward a position away from the cover 27) when viewed from the rear.

As shown in FIG. 6, at least one notch 60 cut downward is provided at a protruding end (i.e., upper end) of the rib 54. In the present embodiment, the rear rib 54R is provided with two notches 60. The left space 56L and the right space 56R are connected to each other via the notch 60. In the present embodiment, a cutout 62 cut downward is provided at the upper end of the rear portion of the rear rib 54R.

As shown in FIG. 3, the cap 29 includes the cap front portion 29F that forms the front portion of the cap 29 and includes the accommodating recess 17, and the cap rear portion 29R that forms the rear portion of the cap 29 and includes a through hole 64 at a position aligned with the power supply device 18. The cap front portion 29F protrudes downward compared to the cap rear portion 29R in a side view. The cap 29 is coupled to the upper surface of the cover 27 with a portion of the cap front portion 29F passing through the front hole 39 of the cover front portion 27A. The cover front portion 27A is covered from above by the cap front portion 29F, and the cover center portion 27B is covered from above by the cap rear portion 29R.

The upper pad member 22 is formed of a material such as polyurethane having cushioning properties. The upper pad member 22 is formed in a plate shape having a surface facing in the up-and-down direction. As shown in FIGS. 4B and 5, the upper pad member 22 is coupled to the upper surface of the cover 27 (specifically, the upper surface of the cover rear portion 27C) and the upper surface of the frame 26 (the side member 31).

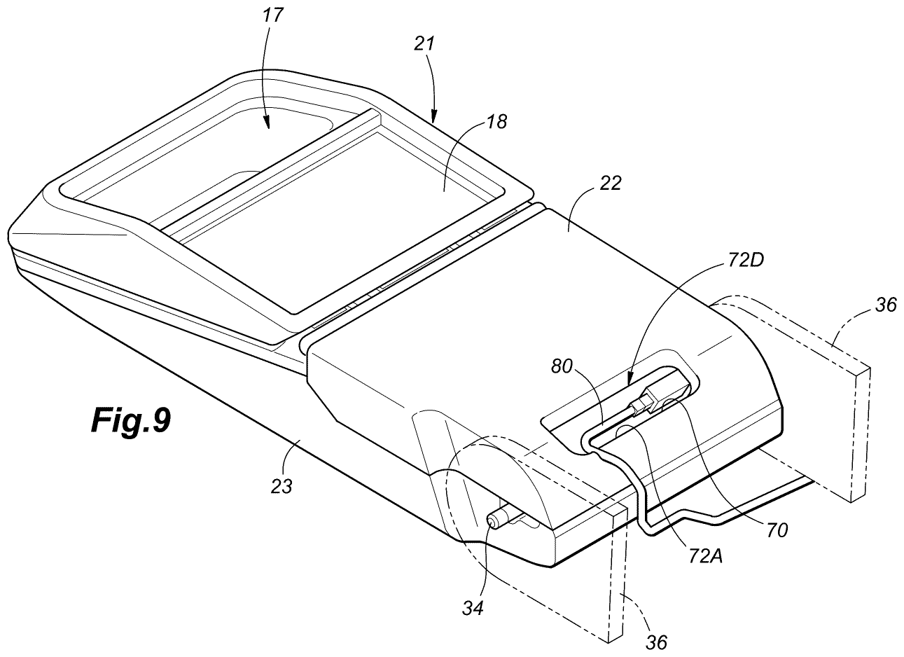

As shown in FIG. 9, the upper pad member 22 is provided with a pad hole 70 penetrating in the thickness direction. As shown in FIG. 2, the pad hole 70 is arranged at the rear end of the armrest 15. In the present embodiment, as shown in FIG. 5, the upper pad member 22 includes an extending portion 68 that extends rearward beyond the cover 27, and the pad hole 70 is formed so that at least a portion of the pad hole 70 overlaps the extending portion 68. The rear end (extended end) of the extending portion 68 preferably extends to the rear of the shaft 34.

The lower pad member 23 is formed of a material such as polyurethane having cushioning properties. The lower pad member 23 is arranged so as to cover the lower surfaces of the frame 26, the cover 27, and the cap 29, and coupled to the lower surface of the frame 26.

The skin material 25 is formed of a sheet-like (or cloth-like) material and covers the outer surface of the upper pad member 22 and the outer surface of the lower pad member 23. The skin material 25 is preferably formed of a breathable fabric material. Alternatively, the skin material 25 may be configured so that the portion overlapping the opening of the pad hole 70 forms a mesh structure. The skin material 25 may be hooked or engaged at the end thereof to the cover 27 or the tray 28 by the hook and the like.

As shown in FIG. 5, with this configuration, inside the armrest 15, a heat exhaust passage 72 is formed that runs from the lower surface of the power supply device 18 through the inside of the tray 28 and the slit 58 to the pad hole 70. As shown by arrows in FIG. 5, the heat from the power supply device 18 is discharged to the outside of the armrest 15 through the heat exhaust passage 72.

The heat exhaust passage 72 includes a flow-through passage 72U that forms the upstream side thereof and a discharge passage 72D that forms the downstream end thereof. The flow-through passage 72U is defined by the space 56 between the cover 27 and the tray 28. The upstream end of the flow-through passage 72U is connected to the power supply device 18, and the downstream end of the flow-through passage 72U is connected to the discharge passage 72D via the slit 58. That is, the slit 58 forms the downstream opening of the flow-through passage 72U, and the flow-through passage 72U opens on the surface (rear surface) of the armrest body 21 at a position that does not overlap the power supply device 18. The upstream end of the discharge passage 72D is connected to the downstream end of the flow-through passage 72U, and the downstream end of the discharge passage 72D is defined by the pad hole 70. That is, the pad hole 70 is formed to penetrate the upper pad member 22 at a position where the pad hole 70 is connected to the flow-through passage 72U, and a heat exhaust outlet 72A of the heat exhaust passage 72 is defined by the pad hole 70. The heat exhaust outlet 72A is arranged above the flow-through passage 72U in a side view.

In the present embodiment, the armrest 15 is provided with a harness 80 for supplying power to the power supply device 18. The harness 80 includes the heat exhaust passage 72 routed therethrough. More specifically, the harness 80 is connected at one end to the lower surface of the power supply device 18, passes through the flow-through passage 72U and the pad hole 70, and extends above the upper pad member 22. By routing the harness 80 through the heat exhaust passage 72 in this manner, there is no need to provide a separate hole and the like in the armrest 15 for routing the harness 80, and the armrest 15 can be configured simply.

Next, the effects of the armrest 15 configured in this manner will be described.

As shown in FIG. 5, the armrest body 21 is provided with the flow-through passage 72U, the upstream side of the flow-through passage 72U being connected to the power supply device 18, and the downstream side of the flow-through passage 72U opening at the rear end that does not overlap the power supply device 18 on the surface of the armrest body 21. Accordingly, heat from the power supply device 18 can be dissipated to a position that does not overlap the power supply device 18. Further, the discharge passage 72D defined by the pad hole 70 is connected to the downstream end of the flow-through passage 72U, and the heat exhaust passage 72 connected to the power supply device 18 is formed in the armrest 15. Accordingly, the heat generated by the power supply device 18 can be more effectively dissipated.

In this way, the power supply device 18 is supported by the armrest body 21 on the front end side thereof. Accordingly, the power supply device 18 can be provided in a position where the power supply device 18 can be easily operated by the seated person in the rear seat 1.

Further, the heat exhaust outlet 72A of the heat exhaust passage 72 is defined by the pad hole 70 arranged at the rear end of the armrest body 21. Accordingly, the heat exhaust outlet 72A can be provided in a less conspicuous position on the armrest 15 compared to the front end of the armrest 15, and the design of the armrest 15 can be improved.

The upper pad member 22 is provided with a pad hole 70 penetrating in the thickness direction and forms the downstream end of the heat exhaust passage 72. The pad hole 70 is provided at the rear end of the armrest 15. This allows the rear end of the armrest 15 to have cushioning properties while allowing heat to be dissipated through the pad hole 70.

In the present embodiment, the upper pad member 22 includes an extending portion 68 that extends rearward beyond the cover 27, and the pad hole 70 is formed to overlap the extending portion 68. This makes it difficult for the cover 27 to obstruct the airflow through the pad hole 70, and allows heat to be efficiently dissipated through the pad hole 70. As shown in FIG. 5, it is preferable that the rear end of the extending portion 68 extends to the shaft 34.

As shown in FIG. 7, the rear wall 45 of the tray 28 is provided with a slit 58 extending in the front-and-rear direction. By providing the slit 58, the space 56 between the cover 27 and the tray 28 is connected to the outside. Accordingly, the heat exhaust passage 72 can be formed in the armrest 15 with a simple structure.

The slit 58 widens toward a position away from the opening 28A of the tray 28, and has a tapered structure in which the width of the slit 58 narrows toward the top. This prevents the warm air discharged to the outside of the tray 28 from flowing back into the inside of the tray 28, and heat can be efficiently dissipated from the armrest 15. Further, when the tray 28 is manufactured by molding using two molds, the molds can be easily separated. This makes it easier to manufacture the tray 28.

Further, the slit 58 passes through the lower end of the rear wall 45 and extends to the bottom wall 41. Accordingly, the area of the opening portion of the slit 58 can be increased as compared to when the slit 58 does not extend to the bottom wall 41, and heat can be efficiently dissipated from the armrest 15.

In the present embodiment, the corner 48 having an arc shape in a side view is provided between the rear wall 45 and the bottom wall 41, and the slit 58 is configured to pass through the corner 48. Accordingly, air flows more easily through the slit 58 as compared to when the rear wall 45 and the bottom wall 41 are connected at a right angle in a side view, and heat can be efficiently dissipated from the armrest 15.

As shown in FIG. 6, the bottom wall 41 of the tray 28 is provided with a rib 54 extending in the front-and-rear direction to increase rigidity. By providing the rib 54, the space 56 between the tray 28 and the cover 27 is partitioned into left and right regions, and there is a risk that heat will be concentrated in one of the left and right spaces 56.

Accordingly, according to the present embodiment, the notch 60 is provided at the protruding end of the rib 54. By providing the notch 60, it is possible to allow heat to efficiently flow through between the spaces 56 arranged on the left and right sides of the rib 54. This prevents heat from being concentrated in one of the left and right spaces 56, and heat can be efficiently dissipated from the armrest 15.

As shown in FIG. 5, the bottom wall 41 is provided with the bottom wall recess 50 that is recessed downward at a position aligned with the accommodating hole 37 in the up-and-down direction. Accordingly, the harness 80 connected to the power supply device 18 and the bottom wall 41 are less likely to interfere with each other, and the connection of the harness 80 to the power supply device 18 can be facilitated.

The bottom wall recess 50 is provided in the front half of the bottom wall 41. Accordingly, the bottom wall 41 is configured to rise toward the downstream side, so that warm air is preferentially discharged from the slit 58, thereby promoting heat dissipation. Further, the distance between the left wall 46L and the right wall 46R in the lateral direction is smaller on the rear end side than on the front end side, so that the air flowing through the heat exhaust passage 72 can be effectively guided toward the slit 58.

In the above first embodiment, an example is described in which one rib 54 is provided on the bottom wall 41, but two or more ribs 54 may be provided on the bottom wall 41. Further, although the slit 58 is provided in the rear wall 45 according to the present embodiment, one or more holes penetrating the rear wall 45 may be provided instead of the slit 58 (or in addition to the slit 58).

In the first embodiment, the pad hole 70 is provided in the upper pad member 22, but the pad hole 70 may be provided in the lower pad member 23. If the upper pad member 22 is made of a foam material having sufficient breathability, or if the upper pad member 22 is thin enough to allow heat to be dissipated, the pad hole 70 does not need to be provided.

### Summary of the First Embodiment

One embodiment is the armrest 15 including: the armrest body 21; and the device (an example of which is the power supply device 18) supported on the surface of the armrest body 21, and the armrest body 21 is provided with the flow-through passage 72U, the upstream side of the flow-through passage being connected to the device, and the downstream side of the flow-through passage opening on the surface of the armrest body 21 at the position that does not overlap the device.

According to this aspect, since the flow-through passage 72U is provided in the armrest 15, heat from the device can be effectively dissipated through the flow-through passage 72U.

In the above aspect, preferably, the armrest body 21 includes at the base end thereof the connection portion (an example of which is the shaft 34) for connecting the armrest body 21 to the seat back 13, the device is supported on the free end side of the armrest body 21, and the downstream end of the flow-through passage 72U is provided on the base end side of the armrest body 21.

According to this aspect, the device can be arranged in a position where the device can be easily operated by the seated person.

In the above aspect, preferably, the armrest includes the pad member (an example of which is the upper pad member 22) coupled to the surface of the armrest body 21, and the skin material 25 covering the pad, and the pad member is provided with the pad hole 70 penetrating through the pad member at a position where the pad hole 70 is connected to the flow-through passage 72U.

According to this aspect, it is possible for the armrest 15 to have cushioning properties while allowing heat to be dissipated through the pad hole 70.

In the above aspect, preferably, the armrest 15 includes the harness 80 connected at one end to the device, and the harness 80 passes through the flow-through passage 72U and the pad hole 70.

According to this aspect, there is no need to provide a separate hole in the armrest 15 for routing the harness 80, and the armrest 15 can be configured simply.

In the above aspect, preferably, the armrest body 21 includes a box body (an example of which is the tray 28) formed in a rectangular tubular shape with the bottom wall 41 and the peripheral walls 42, and a lid (an example of which is the cover 27) that closes the opening 28A of the box body. The lid includes an accommodating hole 37 extending in the up-and-down direction to accommodate the device. The circumferential wall includes a front wall 44 arranged on the free end side, a rear wall 45 arranged on the base end side, and a pair of sidewalls 46 each connecting the edges of the front wall 44 and the rear wall 45. The flow-through passage 72U is defined by the box body and the lid. The rear wall 45 is provided with the slit 58 that forms the downstream opening of the flow-through passage 72U.

According to this aspect, the heat exhaust passage 72 can be formed in the armrest 15 with a simple structure.

In the above aspect, preferably, the slit 58 widens toward a position away from the opening 28A of the box body.

According to this aspect, the heat can be efficiently dissipated from the armrest 15.

In the above aspect, preferably, the slit 58 passes through the lower end of the rear wall 45 and extends to the bottom wall 41.

According to this aspect, the heat can be efficiently dissipated from the armrest 15.

In the above aspect, preferably, the bottom wall 41 is provided with at least one rib 54 connecting the front wall 44 and the rear wall 45.

According to this aspect, the rigidity of the armrest body 21 can be increased.

In the above aspect, preferably, at least one notch 60 is provided at the protruding end of the rib 54.

According to this aspect, it is possible to allow heat to efficiently flow through the armrest 15.

In the above aspect, preferably, the bottom wall 41 is provided with the bottom wall recess 50 recessed at a position aligned with the accommodating hole 37 in the up-and-down direction.

According to this aspect, the connection of the harness 80 to the device can be facilitated.

In the above aspect, preferably, the pad member includes the extending portion 68 that extends toward the base end side beyond the cover, and at least a portion of the pad hole 70 is formed in the extending portion 68.

According to this aspect, the heat can be efficiently dissipated through the pad hole 70.

In the above aspect, preferably, the device is the power supply device 18 for supplying power to the terminal.

According to this aspect, it is possible to supply power to the terminal using the device provided in the armrest.

To achieve such an object, one aspect of the present invention provides a vehicle seat (an example of which is the rear seat 1) including the armrest 15, and the armrest body 21 is rotatably connected to a seat back 13 at a base end side of the armrest body about an axis extending in a lateral direction, and the seat back 13 is provided with a storage recess 16 to store the armrest 15.

According to this aspect, it is possible to provide a vehicle seat including a retractable armrest 15 capable of effectively dissipating the heat from the device.

<<Second embodiment>> In the following, the structure of an armrest 101 according to the second embodiment will be described based on a state in which the armrest 101 is in the use position, as in the first embodiment.

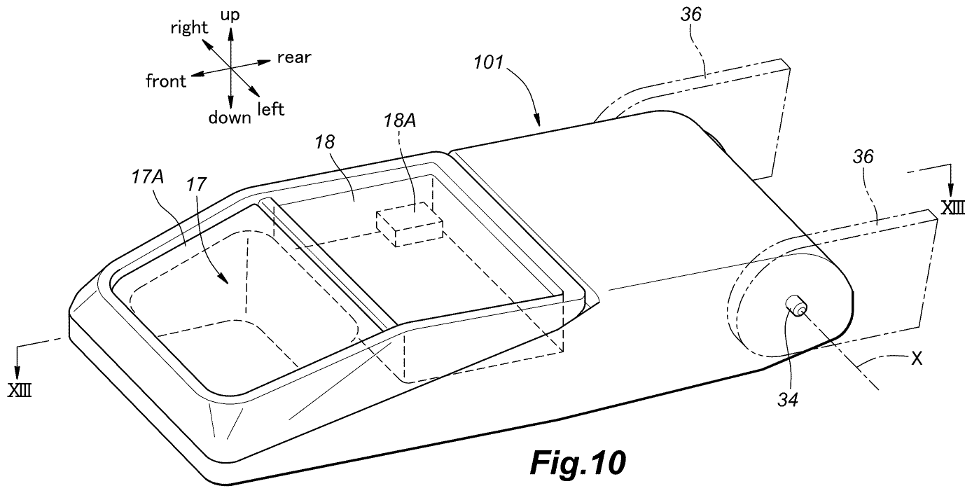

As shown in FIG. 10, as in the first embodiment, the armrest 101 is rotatably connected to the seat back 13 at the base end side about an axis extending in the lateral direction. As in the first embodiment, the seat back 13 is provided with the storage recess 16 to store the armrest 101 (see FIG. 1).

The armrest 101 also includes the accommodating recess 17 on the front end (i.e., free end) side thereof, as in the first embodiment. The accommodating recess 17 is used to accommodate various items such as drinking cups. In the present embodiment, the armrest 101 is provided with the closing member 17A for closing the accommodating recess 17.

The armrest 101 further includes the contactless power supply device 18 for charging terminals such as smartphones. The power supply device 18 is arranged slightly forward of the center of the armrest 101 and positioned behind the accommodating recess 17.

The power supply device 18 according to the present embodiment is provided with a fan 18A for dissipating heat. The fan 18A is provided in the right half of the power supply device 18. An opening (not shown) that communicates with the inside of the case is provided in the right half of the lower surface of the case that forms the outer shell of the power supply device 18. The fan 18A is accommodated inside the case and dissipates heat from the power supply device 18 through the opening.

As in the first embodiment, the armrest 101 includes, in addition to the power supply device 18, an armrest body 103, the upper pad member 22 arranged along the upper surface of the armrest body 103, a lower pad member 105 provided on the underside of the armrest body 103, the skin material 25 covering the outer surfaces of the upper pad member 22 and the lower pad member 105, and the cap 29.

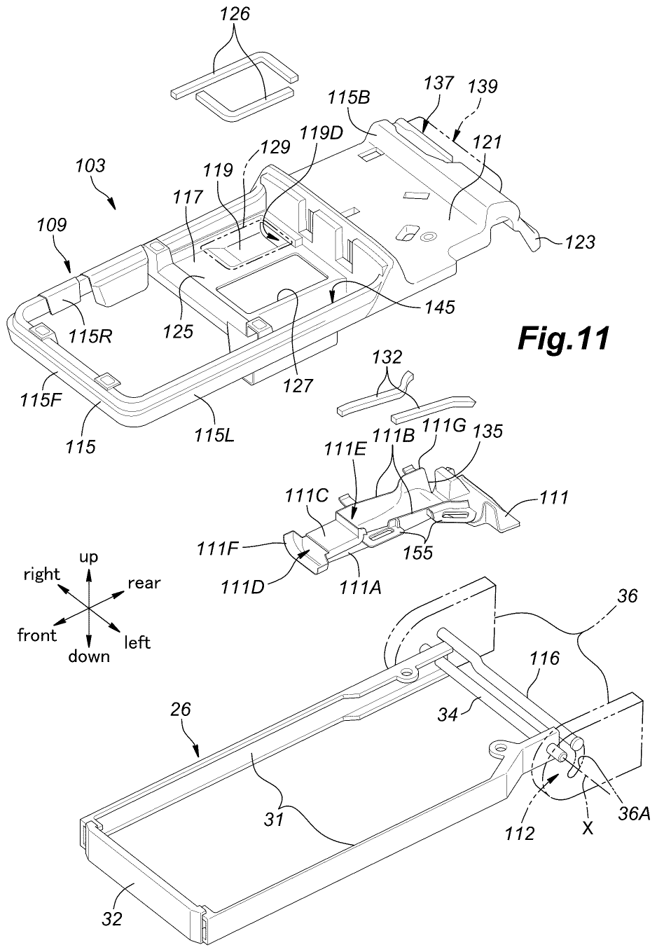

The upper pad member 22, the skin material 25, and the cap 29 of the armrest 101 according to the second embodiment are substantially the same as those according to the first embodiment, and therefore, the description will be omitted. FIG. 11 shows an exploded perspective view of the armrest body 103.

As shown in FIG. 11, the armrest body 103 includes the frame 26, a support member 109 supported by the frame 26, and a duct 111 connected to the support member 109.

As in the first embodiment, the frame 26 includes a pair of left and right side members 31, the front member 32 connecting the left and right side members 31, and the shaft 34.

The shaft 34 is formed of a metal round bar and arranged to extend in the lateral direction. The shaft 34 passes through the through holes provided in the rear portions of the left and right side members 31 and is fixed to the corresponding side members 31 at the through holes.

The left and right ends of the shaft 34 are rotatably supported by the pair of brackets 36 fixed to the seat back frame. Accordingly, the frame 26 is rotatably connected to the seat back 13 about the central axis X of the shaft 34 (also referred to as the rotation shaft) (see also FIG. 10).

As shown in FIG. 11, a restricting mechanism 112 is provided between the armrest 101 and the brackets 36 to restrict the rotation range of the armrest 101. The restricting mechanism 112 includes a rod member 116 provided in the frame 26, and the guide groove 36A provided in the bracket 36.

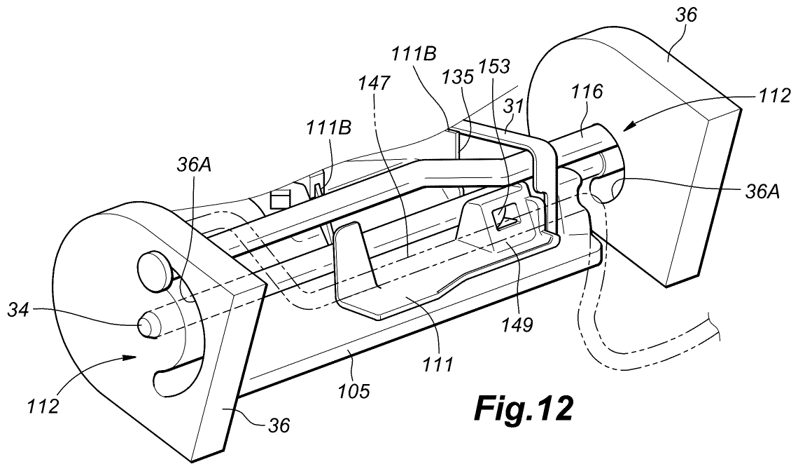

As shown in FIG. 12, the rod member 116 is a rod-shaped member extending in the lateral direction, is coupled to the rear end of the side member 31, and protrudes laterally outward from the pair of brackets 36. Each bracket 36 is provided with the guide groove 36A that receives the corresponding side of the rod member 116, and the rod member 116 is received in the guide grooves 36A. Thereby, the rotation range of the armrest 101 is restricted between the use position and the storage position.

As shown in FIG. 11, the support member 109 is a member made of resin, metal, and the like, and formed in a flat plate shape. The support member 109 is arranged to overlap the side members 31 from above at both left and right edges and to overlap the front member 32 from above at the front edge, and is fixed in place. The support member 109 may be fixed to the frame 26 by screws and the like. The power supply device 18 is arranged on the upper surface of the support member 109 and is supported by the upper surface (also referred to as a top surface) of the support member 109.

More specifically, the support member 109 includes a frame body 115 having a rectangular frame shape extending in the front-and-rear direction, a support portion 117 arranged to connect the front and rear central portions of the long sides of the frame body 115, a connecting portion 119 provided on the support portion 117, and a closing portion 121 provided behind the support portion 117.

The frame body 115 includes a left frame 115L arranged along the side member 31 on the left side, a right frame 115R arranged along the side member 31 on the right side, a front frame 115F connecting the front end of the left frame 115L and the front end of the right frame 115R and arranged along the front member 32, and a rear frame 115B connecting the rear end of the left frame 115L and the rear end of the right frame 115R.

The front frame 115F, the left frame 115L, and the right frame 115R are each arranged along the upper surface of the frame 26. The rear frame 115B passes above the shaft 34 and extends to the rear of the shaft 34. The rear frame 115B further includes an extending portion 123 that extends downward at the rear end. The extending portion 123 is arranged behind the shaft 34 and forms a wall having a surface facing the front-and-rear direction.

The support portion 117 is formed in a plate shape having a surface facing in the up-and-down direction. The support portion 117 has a substantially rectangular shape extending in the lateral direction in a top view. The support portion 117 is coupled at the left edge to substantially the center of the left frame 115L in the front-and-rear direction, and the support portion 117 is coupled at the right edge to substantially the center of the right frame 115R in the front-and-rear direction. The upper surface (top surface) of the support portion 117 forms a surface (hereinafter referred to as support surface 125) that supports the power supply device 18, and the power supply device 18 is arranged on the support surface 125. A sealing member 126 arranged along the edge of an opening portion 129 is provided between the power supply device 18 and the support surface 125.

In the present embodiment, a heat dissipation hole 127 extending in the up-and-down direction is provided at substantially the central portion of the support portion 117 in the lateral direction. The heat dissipation hole 127 has a substantially rectangular shape in a top view.

The support portion 117 is provided with the opening portion 129 penetrating in the plate thickness direction at the right edge of the support surface 125 and at a position facing the fan 18A of the power supply device 18. The opening portion 129 has a substantially square shape in a top view.

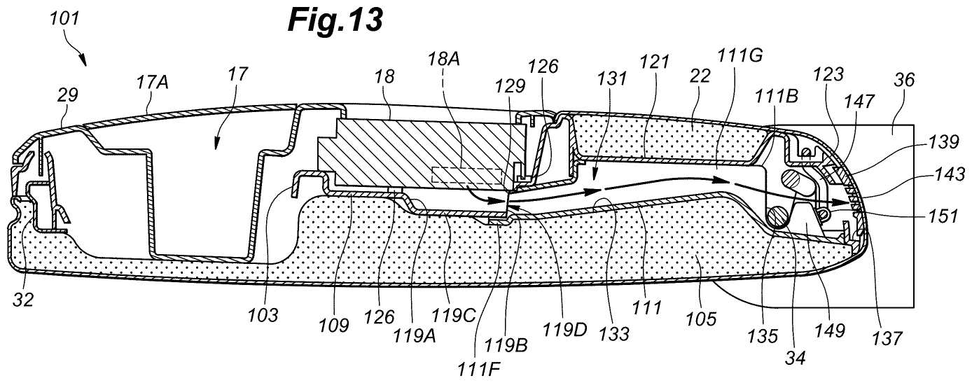

As shown in FIG. 13, the connecting portion 119 is coupled to the opening portion 129 from below and forms a groove extending downward from the opening portion 129.

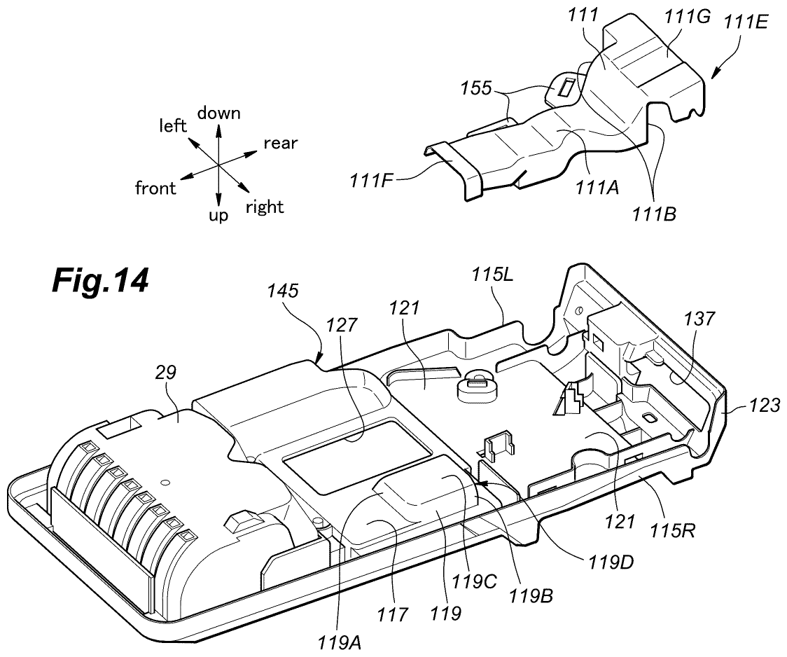

More specifically, as shown in FIGS. 13 and 14, the connecting portion 119 includes a front wall 119A connected to the front edge of the opening portion 129 and extending downward, a pair of left and right sidewalls 119B connected to the left and right side edges of the opening portion 129 and extending downward, and a bottom wall 119C connected to the lower ends of the front wall 119A and the sidewalls 119B and extending rearward. Accordingly, the connecting portion 119 is closed at the front end thereof, has a U-shaped cross-sectional groove extending rearward, and includes an opening portion 119D that opens toward the rear.

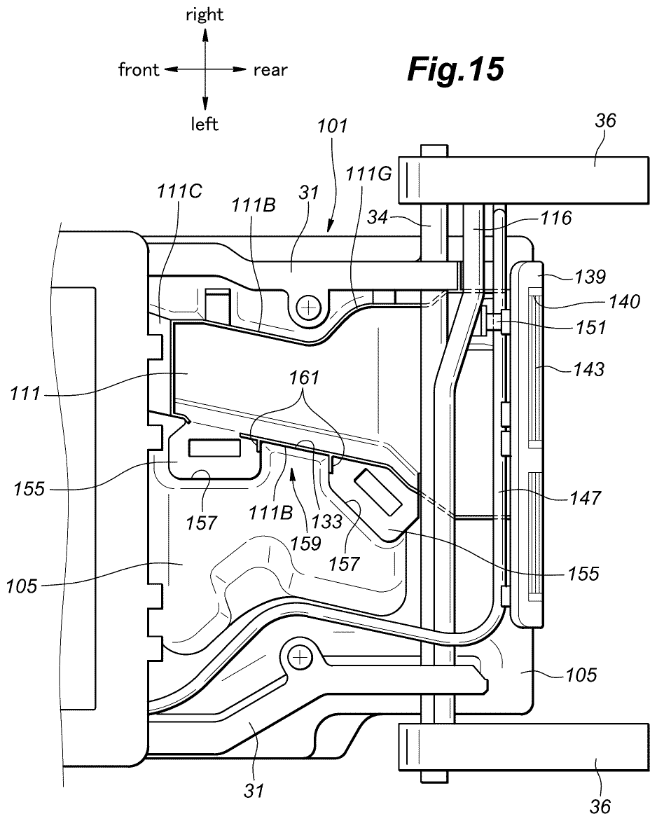

As shown in FIGS. 11 and 14, the closing portion 121 is formed in a rectangular plate shape having a surface facing in the up-and-down direction. The closing portion 121 is coupled to the left frame 115L at the left edge, to the rear frame 115B at the rear edge, and to the right frame 115R at the right edge. As shown in FIG. 15, the upper pad member 22 is arranged on the upper surface of the closing portion 121.

As shown in FIG. 11, the duct 111 includes a bottom wall 111A extending in a substantially horizontal direction, and sidewalls 111B extending upward from the respective left and right edges of the bottom wall 111A. The sidewalls 111B of the duct 111 are connected to each other at substantially the central portions of the upper ends thereof by an upper wall 111C extending laterally. Accordingly, the central portion of the duct 111 is formed in a tubular shape including a front opening portion 111D that opens toward the front and a rear opening portion 111E that opens toward the rear.

Further, the front end of the duct 111 is provided with a front groove portion 111F, which is a groove formed by the front portion of the bottom wall 111A and the front portions of the left and right sidewalls 111B. The rear end of the duct 111 is also provided with a rear groove portion 111G, which is a groove formed by the rear portion of the bottom wall 111A and the rear portions of the left and right sidewalls 111B. The front groove portion 111F and the rear groove portion 111G each have a U-shaped cross section that opens upward. By providing the front groove portion 111F and the rear groove portion 111G, the duct 111 is formed in a groove shape at the front end and the rear end.

The duct 111 extends in the front-and-rear direction, and the front groove portion 111F is arranged so as to cover the connecting portion 119 from below. Accordingly, the duct 111 is connected to the connecting portion 119 at the front end in the central portion. At this time, the closing portion 121 is arranged above the rear groove portion 111G, and the rear groove portion 111G (the rear end portion of the groove-shaped duct 111) is arranged to face the closing portion 121 vertically. Further, the upper edges of the rear portions of the sidewall 111B respectively abut against the lower surfaces of the closing portion 121, and the rear groove portion 111G is closed by the closing portion 121 from above. Accordingly, as shown in FIG. 13, a passage 131 that extends from the connecting portion 119 to the rear end of the duct 111 is defined by the duct 111 and the support member 109. Accordingly, the duct 111 can be referred to as a passage forming member (or flow path forming member) that cooperates with the support member 109 to form the passage 131, and the support member 109 can be referred to as a lid member that closes the upper side of the rear groove portion 111G. As shown in FIG. 11, it is preferable to provide sealing members 132 between the duct 111 and the closing portion 121 to seal the gap between the sidewalls 119B (the rear portions of the sidewalls 119B) that constitutes the rear groove portion 111G and the closing portion 121.

The front groove portion 111F of the duct 111 may be adhered to the connecting portion 119, and the duct 111 may be configured to be biased upward by the lower pad member 105 so as to be maintained in a state where the duct 111 is connected to the connecting portion 119.

As shown in FIGS. 13 and 15, the lower pad member 105 is provided with a receiving recess 133 that is recessed downward to receive the connecting portion 119 and the duct 111. By providing the receiving recess 133, the lower pad member 105 is satisfactorily coupled to the support member 109 and the duct 111.

As shown in FIG. 13, a notch portion 135 cut downward from the upper edge (i.e., in the direction away from the support member 109) is provided at each rear portion of the sidewalls 111B of the duct 111. The notch portion 135 is provided in the sidewall 111B that constitutes the rear groove portion 111G (see also FIG. 11). The shaft 34 passes through the notch portion 135 of the duct 111. Accordingly, the passage 131 defined by the duct 111 and the support member 109 is configured to overlap the shaft 34 in a side view.

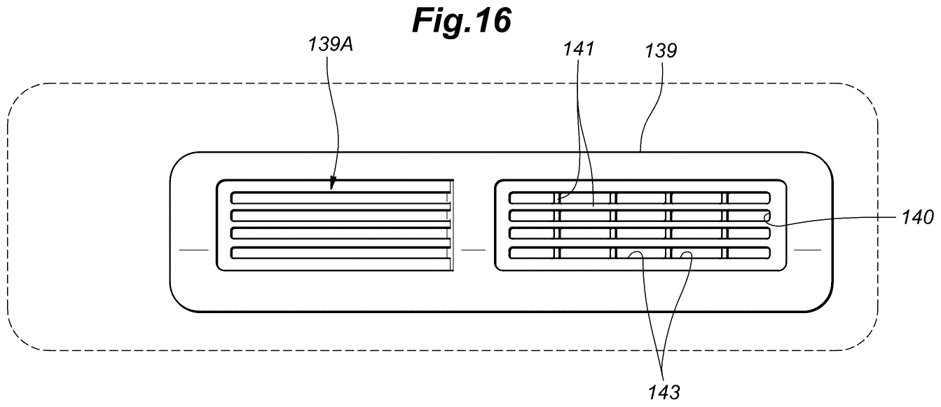

The rear end of the duct 111 extends to the vicinity of the front surface of the extending portion 123. The extending portion 123 is provided with a through hole 137 (see also FIG. 14) formed at a position facing the front-and-rear direction at the rear end of the duct 111. The extending portion 123 is provided with a rear cover member 139 that closes the through hole 137. As shown in FIGS. 15 and 16, the rear cover member 139 is formed in a plate shape having a rectangular shape in a front view. The rear cover member 139 is provided with a through hole 140 penetrating at the rear of the rear end of the duct 111. As shown in FIG. 16, the through hole 140 is provided with a lattice frame 141 extending in the up-and-down direction and the lateral direction. Accordingly, the rear cover member 139 is provided with a plurality of vent holes 143 arranged in the vertical and lateral directions. The rear cover member 139 is provided with a design portion 139A (see FIG. 16) to improve the design of the armrest 101, however, the design portion 139A is not essential.

As shown in FIG. 11, the support portion 117 is provided with a harness hole 145 penetrating the left side of the heat dissipation hole 127. As in the first embodiment, a harness 147 is connected to the power supply device 18. The harness 147 passes through the harness hole 145, reaches between the support member 109 and the lower pad member 105, and further extends rearward. As shown in FIG. 15, the harness 147 further passes through the rear cover member 139 and the duct 111, and extends to the gap between the bracket 36 and the armrest 101 (see also FIG. 12).

In the present embodiment, as shown in FIG. 12, a fixing portion 149 for fixing the harness 147 is provided on the rear edge of the bottom wall 111A of the duct 111 to stably hold the harness 147 between the rear cover member 139 and the duct 111. The fixing portion 149 is provided with a locking hole 153 into which a harness clip 151 (see FIGS. 13 and 15) is locked. The harness 147 is fastened to the harness clip 151, and the harness clip 151 is locked into the locking hole 153. Accordingly, the harness 147 is locked to the rear edge of the duct 111 and held between the rear cover member 139 and the duct 111. Further, by providing the fixing portion 149 for fixing the harness 147 on the duct 111, there is no need to provide a separate member for fixing the harness 147 to the support member 109, and the number of components of the armrest 101 can be reduced.

As shown in FIGS. 11 and 15, a pair of front and rear restricting pieces 155 are provided on at least one of the sidewalls 111B of the duct 111. The restricting pieces 155 are arranged at intervals on the upstream side (front side) and downstream side (rear side) of the sidewall 111B provided on the rear portion of the duct 111.

The restricting pieces 155 each extend parallel to the bottom wall 111A from the sidewall 111B and protrude toward the lower pad member 105. The restricting pieces 155 are each formed in a plate shape having a surface facing in the up-and-down direction. The restricting piece 155 may also be referred to as a tab or a planar rib because of the shape thereof. In the present embodiment, the restricting piece 155 protrudes leftward from the lower edge of the left sidewall 111B of the duct 111.

The lower pad member 105 is provided with a recessed portion 157 formed at a position corresponding to the restricting piece 155. Accordingly, the lower pad member 105 extends into a space between the pair of front and rear restricting pieces 155 arranged between the recessed portions 157. Hereinafter, the portion of the lower pad member 105 arranged between the restricting pieces 155 will be referred to as a bulging portion 159. The bulging portion 159 extends into a space between the pair of front and rear restricting pieces 155, and restricts the front and rear movement of the lower pad member 105 relative to the support member 109.

Each of the restricting pieces 155 is provided with a rib 161 projecting upward and having a surface, the surface of the rib of one of the restricting pieces facing the surface of the rib of the other, In the present embodiment, the rib 161 provided on the front restricting piece 155 extends in the lateral direction along the rear edge of the front restricting piece 155. The rib 161 provided on the rear restricting piece 155 extends in the lateral direction along the front edge of the rear restricting piece 155. Accordingly, the two ribs 161 each have a surface, with the surfaces of the ribs facing each other in the front-and-rear direction.

The bulging portion 159 is sandwiched between the rear surface of the rib 161 provided on the front restricting piece 155 and the front surface of the rib 161 provided on the rear restricting piece 155. This more firmly restricts the front and rear movement of the lower pad member 105 relative to the support member 109.

Next, a manufacturing method of the armrest 101 configured in this manner will be described. An operator manufacturing the armrest 101 first forms the frame 26 of the armrest 101 by coupling together the pair of left and right side members 31, the front member 32, and the shaft 34. The operator then couples the rod member 116 to the frame 26. Next, the operator couples the duct 111 to the support member 109, and then couples the power supply device 18 to the support member 109. Next, the operator couples the upper pad member 22, the lower pad member 105, and the cap 29 to the support member 109 and the frame 26, and covers the upper pad member 22 and the lower pad member 105 with the skin material 25, thereby completing the manufacture of the armrest 101.

Next, the effects of the armrest 101 configured in this manner will be described.

The air heated by the heat generated by the power supply device 18 is discharged by the fan 18A through the opening provided in a case. The air flows downward through the opening portion 129 and the connecting portion 119 provided in the support portion 117, and enters into the passage 131 between the duct 111 and the support member 109. Thereafter, the air that has flowed between the duct 111 and the support member 109 is discharged to the outside of the armrest 101 via the vent hole 143 of the rear cover member 139 (see the arrow in FIG. 13).

In this way, the passage 131 functions as the flow-through passage to release heat from the power supply device 18. An upstream side of the passage 131 is connected to the power supply device 18, and a downstream side of the passage 131 opens on the surface of the armrest body 103 at a position that does not overlap the power supply device 18. Accordingly, heat from the power supply device 18 can be effectively dissipated through the passage 131.

The downstream end of the passage 131 is provided with the rear cover member 139 having the vent hole 143. By providing the rear cover member 139, it is possible to prevent foreign matter from entering the passage 131. Further, a portion of the flow-through passage for dissipating heat that is connected to the power supply device 18 can be formed by a simple configuration of the duct 111 and the support member 109.

This concludes the explanation according to the second embodiment, but the present invention is not limited to the above embodiment and can be widely modified and implemented.

In the above second embodiment, an example is described in which the lattice frame 141 is provided in the through hole 137, but instead of the lattice frame 141, the rear cover member 139 may be provided with a frame extending in the up-and-down direction (or the lateral direction), and the slits may be formed side by side in the rear cover member 139.

1. An armrest comprising:
an armrest body; and
a device supported on a surface of the armrest body, wherein
the armrest body is provided with a flow-through passage, an upstream side of the flow-through passage being connected to the device, and a downstream side of the flow-through passage opening on the surface of the armrest body at a position that does not overlap the device.

2. The armrest according to claim 1, wherein
the device is supported on a free end side of the armrest body, and
a downstream end of the flow-through passage is provided on a base end side of the armrest body.

3. The armrest according to claim 1, wherein a downstream end of the flow-through passage is provided with a cover including a vent hole.

4. The armrest according to claim 1, wherein the armrest body includes a support member on which the device is arranged and a duct supported by the support member,
the support member includes a support portion that forms a surface for supporting the device on a top side, and a connecting portion that opens at the support portion and extends to a back side, and
the duct is formed in a groove shape at a position facing the support member, is connected to the connecting portion, abuts against a back surface of the support member, and defines the downstream side of the flow-through passage.

5. The armrest according to claim 4, wherein the armrest body is provided with a rotation shaft for rotatably connecting the armrest body to a seat back, and
the rotation shaft extends in a lateral direction and passes through the duct.

6. The armrest according to claim 5, wherein the duct includes a bottom wall and a pair of sidewalls extending upward from the bottom wall,
each of the pair of sidewalls is provided with a notch portion cut in a direction away from the support member, and
the rotation shaft passes through the notch portion.

7. The armrest according to claim 4, wherein a fixing portion for fixing a harness connected to the device is provided on a downstream side of the duct.

8. The armrest according to claim 4, wherein a pad member is provided on the back side of the armrest body, and
the pad member is provided with a receiving recess that receives the connecting portion and the duct.

9. The armrest according to claim 8, wherein the duct is provided with a pair of restricting pieces protruding toward the pad member, and
the pad member is provided with a bulging portion extending into a space between the pair of restricting pieces.

10. The armrest according to claim 9, wherein each of the pair of restricting pieces is provided with a rib having a surface, the surface of the rib of one of the restricting pieces facing the surface of the rib of the other, and
the bulging portion is sandwiched between the ribs.

11. The armrest according to claim 1, wherein the device is a power supply device for supplying power to a terminal.

12. A vehicle seat including the armrest according to claim 1, wherein
the armrest body is rotatably connected to a seat back at a base end side of the armrest body about an axis extending in a lateral direction, and
the seat back is provided with a storage recess to store the armrest.
